(19) United States
(12) Patent Application Publication
(10) Pub. No.: US 2009/0063273 A1
(43) Pub. Date: Mar. 5, 2009

(54) PAY-FOR-PERFORMANCE JOB ADVERTISING

(76) Inventor: Jeff Dixon, (US)

Correspondence Address: BLACK LOWE & GRAHAM, PLLC, 701 FIFTH AVENUE, SUITE 4800, SEATTLE, WA, 98104, US

(21) Appl. No.: 12/121,284

(22) Filed: May 15, 2008

Related U.S. Application Data
(60) Provisional application No. 60/938,135, filed on May 15, 2007.

(51) Int. Cl. G06Q 30/00

(52) U.S. Cl. 705/14

(57) ABSTRACT

A method includes electronically posting an advertisement of a job opening with an employing entity, receiving a notification that an applicant has applied to fill the advertised job opening, and after receiving the notification, charging the employing entity a predetermined fee.

### CROSS-REFERENCE TO RELATED APPLICATIONS

This application claims priority to U.S. Provisional Patent Appl. No. 60/938,135 filed May 15, 2007, which is incorporated by reference as if fully set forth herein.

### FIELD OF THE INVENTION

Embodiments of the invention concern a set of enabling innovations for pay-for-performance job advertising and job targeting optimization.

### BACKGROUND OF THE INVENTION

Traditional job advertising on job boards is inefficient: employers pay the same fee for a posting on a job board regardless of how many qualified prospects they actually obtain, and regardless of how much or little demand there is for the position they are trying to fill.

The Job Advertising Market

Online job advertising is a large and established category to the tune of $4B+/year in the U.S.

The job board model is proven to work (a) with scale (e.g. Monster, Careerbuilder) and (b) in specific niche markets (e.g. pharmaceuticals, technology, legal, accounting).

The job board model is to charge employers for postings and resume search, and then spend to acquire the amount of jobseeker traffic needed to deliver enough candidates for each post and enough resume results for each search, to justify the pricing of posts and access to resume databases. The model works when the aggregate dollars spent by posters/resume searchers exceeds the dollars required to acquire the candidate traffic and applications. But, the job board model has some significant flaws/imperfections.

Job Board Advertising is not Targeted.

The job board is only as good as the traffic it obtains. As destination sites, job boards do little to nothing to get the right job in front of the right person wherever they might be (e.g. on other sites).

Since the job board model is reliant on efficient traffic acquisition, it is vulnerable to competitive pressures from a player who is able to more cheaply or freely acquire traffic of similar or greater value.

Customers calculate ROI based on the number of qualified candidates delivered per dollar spent while job boards charge for posts regardless of the number of qualified candidates delivered.

### DETAILED DESCRIPTION OF THE PREFERRED EMBODIMENT

Embodiments of the invention enable a new business model for online job boards, including a pay-for-performance pricing model. Rather than a flat fee, employers pay based on the number of qualified and/or interested applicants, a more efficient measure of the real value provided by a job board.

Embodiments of the invention feature jobs both on a job search engine (such as, for example, the Jobster.com job search engine) and on a network of affiliated sites. The choice of where and how to feature jobs may be based on the type of job, the amount the employer is willing to pay per qualified applicant, and the demographics and effectiveness of different venues.

Embodiments of the invention may include a novel scheme for featured placement within job search results.

In an embodiment, search results combine paid-for featured job advertisements with unpaid-for job advertisements from other job boards across the web. The traditional approach of fixed slots for featured positions results in a very limited inventory of featured positions and can severely distort relevance.

Embodiments of the invention use featuredness as a weighed factor in the full-text relevance equation to determine the page that a particular featured job occurs in. Within a page of the result set, featured results bubble to the top of the page. By choosing the right weighting for featured jobs, one can effectively use featured status as a “tie breaker” in a ranking algorithm without unduly distorting relevance.

This two-step process of an embodiment effectively creates an unlimited inventory for relevant featured jobs. It also ensures that they occur above the fold whenever possible.

Embodiments of the invention include feedback loops to adjust the number and location of featured impressions that a particular job receives, based on the likelihood that qualified applicants will apply for it.

By gathering data on the effectiveness of particular job advertisements and using that to influence which jobs receive the most impressions, an embodiment can maximize the overall number of qualified applicants and maximize the revenue for the job board.

Embodiments of the invention include a framework that permits one to gather and analyze large amounts of data on the impressions, clickthroughs, and applications for large number of jobs.

A particular job might have a high bid and a high raw relevance score (because of carefully optimized keyword selection) but in fact be undesirable for many applicants. Therefore it doesn't make sense giving that job an overly large number of impressions.

A market-based mechanism can be used to set the price per qualified application based on the supply and demand for particular categories of positions.

Embodiments of the invention include a pay-per-contact model to allow employers to decide on a case by case basis whether an applicant is “qualified”. The traditional approach is based on qualifying questions, as seen in applicant tracking systems. This is labor intensive and not always effective. In an embodiment, automatic processing of a standard online resume or profile allows the elimination of personally identifiable contact information while retaining work qualifications. If a recruiter determines that an applicant is qualified and should be contacted, they pay to make the contact

Job distribution and targeting: The combination of pay-for-performance and targeting technology enables a more distributed approach to job advertising. Jobs can be distributed not only on the central job board but also among a network of affiliated job boards and general interest web sites and blogs.

One approach to the matching of jobs to sites may be based on categorization of jobs (through methods including but not limited to Bayesian classification) and historical data on the effectiveness of different sites for jobs in each category.

A more market-efficient performance based model (e.g. pay per qualified candidate) can improve on the flat rate model as measured by customer value by enabling customers to more directly pay for actual results. As opposed to the fixed-fee model, such a performance based model could also more closely track the market demand for different types of jobs across regions (e.g. the market rate for a qualified nursing candidate in Topeka may vary greatly from the same position in New York City, while the market demand/value of a Ruby developer in Topeka might vary greatly from the nurse in Topeka, thus necessitating different market-driven price points for such candidates).

Embodiments of the invention include a new performance-based targeted advertising system for jobs. The service can be a pay-per-inquiry service in which employers set their desired price per candidate and an embodiment fetches them candidates for their positions both on and off “properties” held by one practicing an embodiment until their budget is satisfied. Goal can be drive towards more pay-per-qualified-candidates over time.

Embodiments of the invention include performance based targeted job advertising both on and off properties held by one practicing an embodiment. A “property” as used herein may refer to a site name such as wwwjobster.com or www.nursingjobs.com or any name which has a unique set of content and is its own “destination” for the purposes of end-users finding it and using it.

By implementing a pay for performance model, an embodiment delivers real value to job advertisers. In the general advertising market, pay-for-performance cost-per-click (CPC) advertising has grown faster than general cost-per-thousand impressions (CPM) advertising (the analog to job board advertising). CPC may be defined as a payment model for advertising whereby the advertiser only pays when an end-user clicks on the ad, as opposed to just seeing the ad. Payment may be on a per-click basis. Advertisers buy clicks on ads from publishers at a given CPC rate, typically a few cents per click although sometimes much more. Some of the larger networks set CPC rates based on an auction marketplace, but they can also be negotiated and fixed for a given ad deal. CPM may be defined as an internet ad model where the publisher gets paid based on the number of times they show the ad to end-users. Each time the ad is shown is an “impression” of the ad. CPM is the rate for a thousand impressions of the ad.

Not all jobs are worth the same amount and is a fundamental flaw of the pay-per-post advertising that job boards promote. A nursing post should not be valued the same as an entry-level accountant post, yet is exactly today's job board model.

Unique to advertising in a specific vertical (jobs) and “owning” the inquiry page, an embodiment is in a unique position to take pay-for-performance one step further by measuring and paying on a cost-per-action basis.

With a traditional job-board payment/ad model, the incentive for the publisher is to buy volume, but cheap, traffic, and to hoard it. It tends to favor being a “destination” site. This is not so good for the advertiser, which wants to have as broad an exposure as possible to cast the widest possible net to get applicants for their job. With a job board the net will only be as wide as the job board's traffic acquisition buys.

With a cost-per-action or cost-per-applicant (CPA) model (discussed in greater detail below), the economic incentive is to get the applicant, not to get impressions. Therefore the publisher of the ad isn't hung up about driving traffic to exclusively its site; rather the publisher also wants to cast a wide net of distribution for the job ad. Better yet, because the publisher still likely has limited inventory and does have some non-zero costs to distribute the ad, the publisher is incentivized to “target” the ad to an audience of end-users that are most likely to apply for the job and most likely to be qualified for the job. It doesn't matter what site the applicant comes in on as long as they meet the qualifications for the job. The market is efficient because the desires and incentives of the publisher for qualified applicants and the desires of the advertiser for qualified applicants are more aligned.

In the case of the CPA model, the payment on the ad comes not when an impression occurs, or even when the ad is clicked, but rather when the ad “converts” by the end-user taking action on it. In the general case of CPA(ction) ads this is usually a product purchase, but in the case of an embodiment as it may pertain to job advertising, the action may be defined as an end-user applying for the job, or Cost-Per-Applicant. Rates for CPA will be the highest in dollar terms, because you lose the “tire-kicker” end-users through the funnel of impression to click to action of applying.

In a “traditional” payment model for job boards, each job is an ad, and to post a job requires a fixed flat rate that's constant for all jobs and usually quite expensive, on the order of several hundreds of dollars for 30 days of exposure. Unlike a CPM model there is no guarantee of the number of impressions, and your costs do not vary based on how many people see it. In CPM there's incentive for the publisher to drive traffic to the ad or else they don't get paid. With the traditional job board model, the risk is almost entirely shifted to the advertiser (employer), in that they pay flat rate for the job posting whether they get any impressions/clicks/applicants or not. It is not a performance-based model. The only incentive that the job board (publisher) has for driving traffic is that they'd like repeat business from the advertiser, so they'd better drive some traffic. The quantity of traffic is not easily quantifiable by the advertiser, and as long as the job board drives “some” traffic they'll be considered to have done their job. As a consequence, the job boards go for cheap traffic acquisition, so generally speaking the job board traffic is not very targeted (e.g., ads on the side of busses, TV advertising) and the job boards tend to want to hoard their traffic since it was expensive to acquire. The job boards are thus jealous of their inventory of impressions; they don't want to give away that traffic to other destination sites.

By developing an expertise in job advertising distribution an embodiment builds relative advantage. Embodiments of the invention include a data-mart that houses historical information about various channels and their inquiry and quality performance based on job characteristics (e.g., job function, location, industry, hiring organization, etc.). This asset can be optionally advantageous to drive forecasting and yield management algorithms that yield more, higher-quality inquiries on and off properties held by one practicing an embodiment at a decreasing cost. Building the traffic and inquiries from a website plays an optionally advantageous role in driving down these costs.

### EMBODIMENTS OF THE INVENTION INCLUDE

Subscription revenue retention and consistent moderate level of new sales via manually driving candidates to apply for our customers' jobs (subscribers and free job posts) by posting their jobs, distributing links to their applications, using off-shore help, etc., so that we can:
(a) better satisfy the needs of our customers than our tools do themselves, and
(b) start tracking the efficacy of various channels and building knowledge about how to efficiently create candidate flow for various types of positions.

What's different here is instead of using our marketing dollars to get general traffic to our site, we use those dollars to generate candidates for our customers. And, instead of focusing account management around training people to use the tool, we put out client services team to work on generating candidates for our clients regardless of whether they use the subscription tool.

Building a self-service system for pay-for-performance (pay per candidate) targeted job advertising on a website and other sales process improvements.

Continuing to build up a website and all of its user touch points (e.g., alerts) as a valuable targeting destination and as service we can export to partners for targeting on their sites.

Pay for performance job advertising with a payment model that charges employer advertisers only when a jobseeker applies for the job.

Job advertising network, both on internet properties held by one practicing an embodiment, as well as on other relevant internet sites, that targets job ads to sites that are most likely to result in a qualified applicant based on matching the job ad attributes with the attributes of the site based on site demographics and the historical performance of that site on similar jobs.

Placement of featured jobs with job search results based on relevance and a boost factor.

Feedback loop for tuning placements based on performance of similar jobs.

Market-based pricing for each qualified applicant based on supply and demand for categories of jobs in a given locale.

Dynamic Pricing/Bid Management

Real-time forecasting and yield management tools

Automation of external distribution (Smartpost, Google Adwords, etc.)

Mechanisms to measure and manage inquiry quality

Increase flexibility of ecommerce platform to manage upfront payments or post payment

Performance Based Targeted Job Advertising System Performance-Based Job Advertising.

Embodiments of the invention include a core competency in understanding the value of a candidate for a particular type of position as well as how to charge customers for such value.

### Targeted Job Advertising

Embodiments of the invention include a core competency in understanding how best to target job advertisements to develop optionally advantageous candidate flow and how to do so at economical rates vs. what employers are willing to pay for such candidates.

Problems Solved:

Above the fold placement of featured jobs is much more likely to be effective

Inventory availability

Visual differentiation

Jobseeker Relevance

Plan

Embodiments of the invention include a featured relevance “boost” to featured ads:

The Lucene full-text engine (and others like it) support ranking based on a set of weighted terms. Featuredness is one such weighted term, other factors include keyword matches with the job description and title, recency of the job, etc. The featuredness boost is chosen to balance between excessive relevance distortion vs. showing featured results.

Within each page of job search results, we bubble featured jobs to top of the result list (overriding the “organic” order). This is in addition to the tweaks to the overall relevance formula which influence the page of job search results that a particular job lands in.

Featured jobs are identified as such by an unobtrusive label but otherwise appear similar to standard jobs.

Focus: Featured Posting (Alternative being Focusing on General Advertising)
Where the majority of online career dollars are spent
Delivers more direct feedback to recruiters
Better solution for hiring mangers; doesn't require ad sale or third part agencies
Good third party solutions exist for general advertising
No one does job advertising/distribution well yet; it's less competitive since its focus in narrower

Model: Pay Per Inquiry (PPI)
Disruptive model since we don't yet depend on posting revenue (Monster and CB are too addicted to posting revenue to change their business model)
Closer to pay for performance than posting (Monster/CB) or even CPC models
Can easily be extended to pay-per-qualified-inquiry however we choose to define it (e.g., qualifying questions, pay to contact, etc.)
Allows an embodiment to leverage external distribution channels easily (job distribution arbitrage);
Novel approach—Good PR and marketing opportunities

Unit Sold: the Job (Alternative being Specific Keywords)
More easily extensible to external channels who don't embrace the notion of tags or keywords
Easy to understand product offering
Gives an embodiment ultimate flexibility in distributing product wherever it sees fit

Placement: Sponsored Section of Search Results Page on Jobster.com (Short-Term)

It's the majority of our page views and is the most relevant and least ‘spammy’

Pricing: Fixed Variable Pricing (Short-Term); Market-Based Dynamic Pricing

Lack of bid system shortens time to market

Payments: Charge Upfront Payment that Hiring Managers can Draw Down and Automatically Refresh when Balance Runs Below a User Defined Threshold

Limits the fixed per transaction costs associated with low-price point transactions.

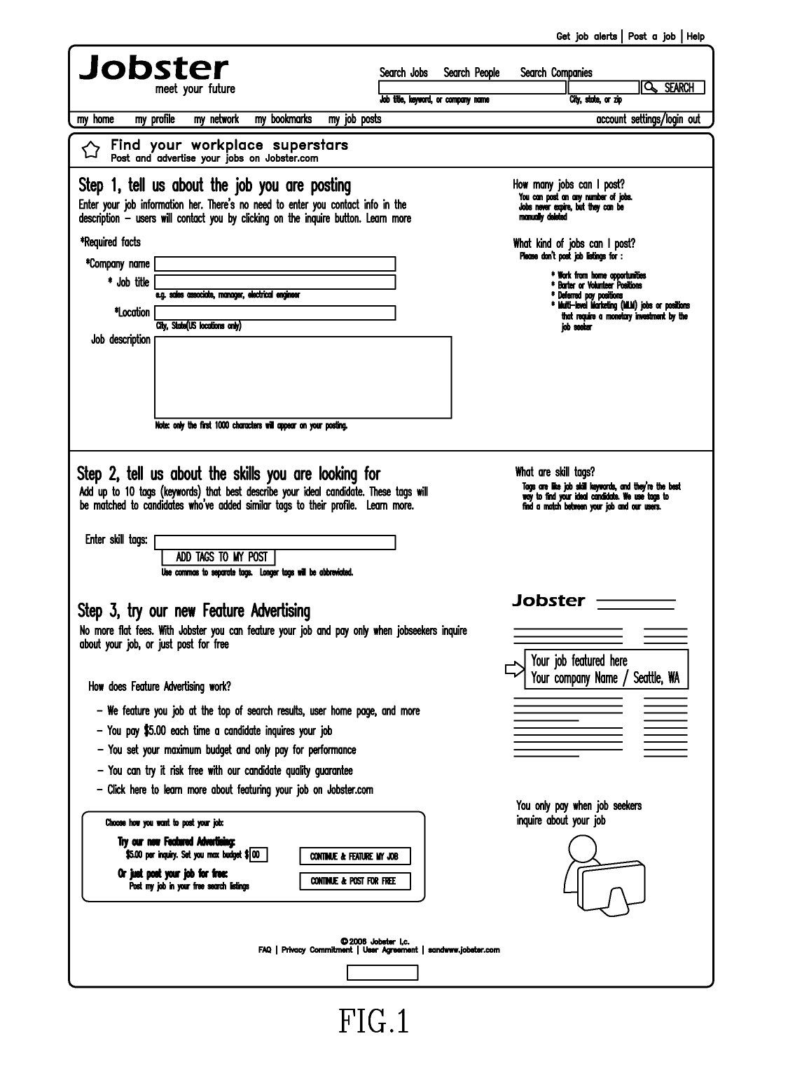

FIG. 1 illustrates an ecommerce self-service mechanism for posting a job advertisement. The top part of the page pertains to collecting data about the job for analysis (such as a job description) and the bottom part solicits the employer advertiser about whether they want to feature and target the job or just post unfeatured and untargeted for free.

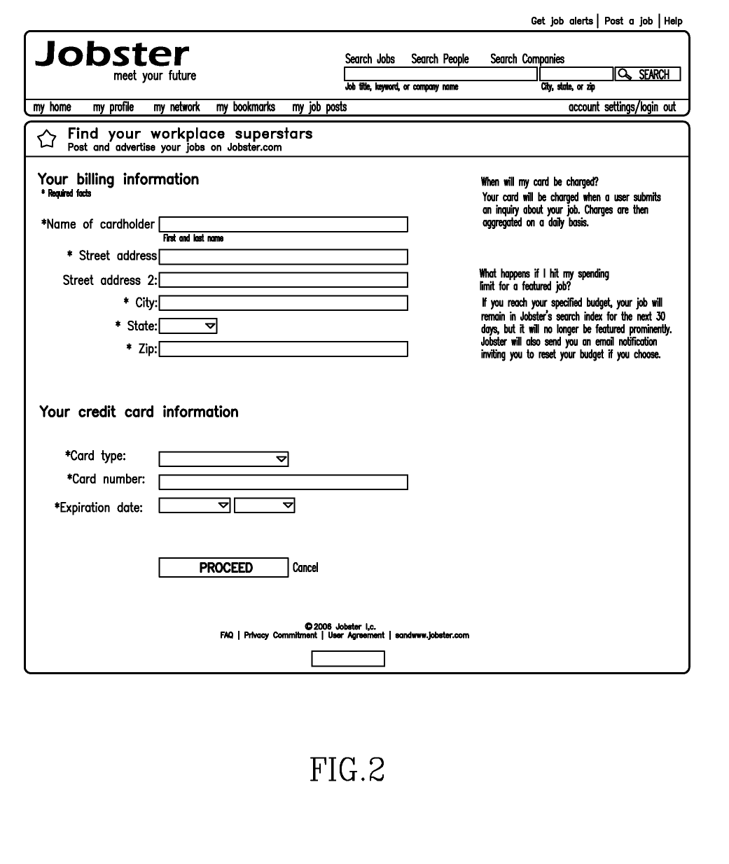

FIG. 2 illustrates an elaboration on the self-service pages for collecting data about the job and for collecting ecommerce payment information about the poster.

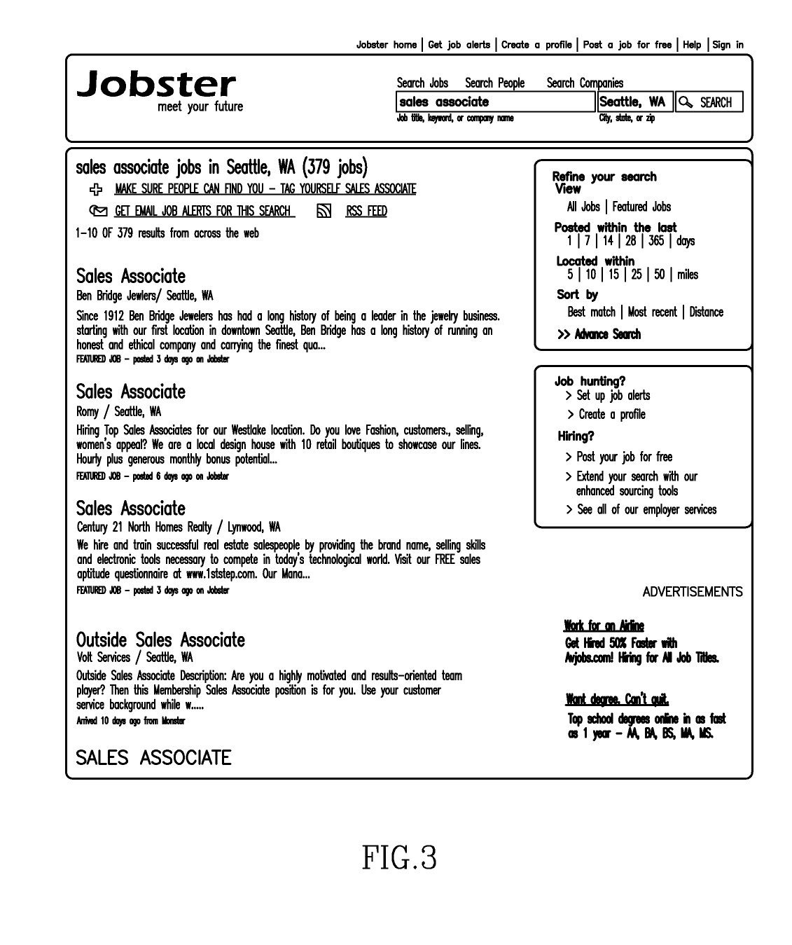

FIG. 3 illustrates how featured jobs are displayed at the top of the search results page with a boosted ranking, however the jobs are relevant to the search query that the user typed in so irrelevant jobs are filtered out even if the irrelevant jobs are featured. Also shows low-key treatment for denoting featured jobs, vs. a callout box with a colored background used in previous approaches.

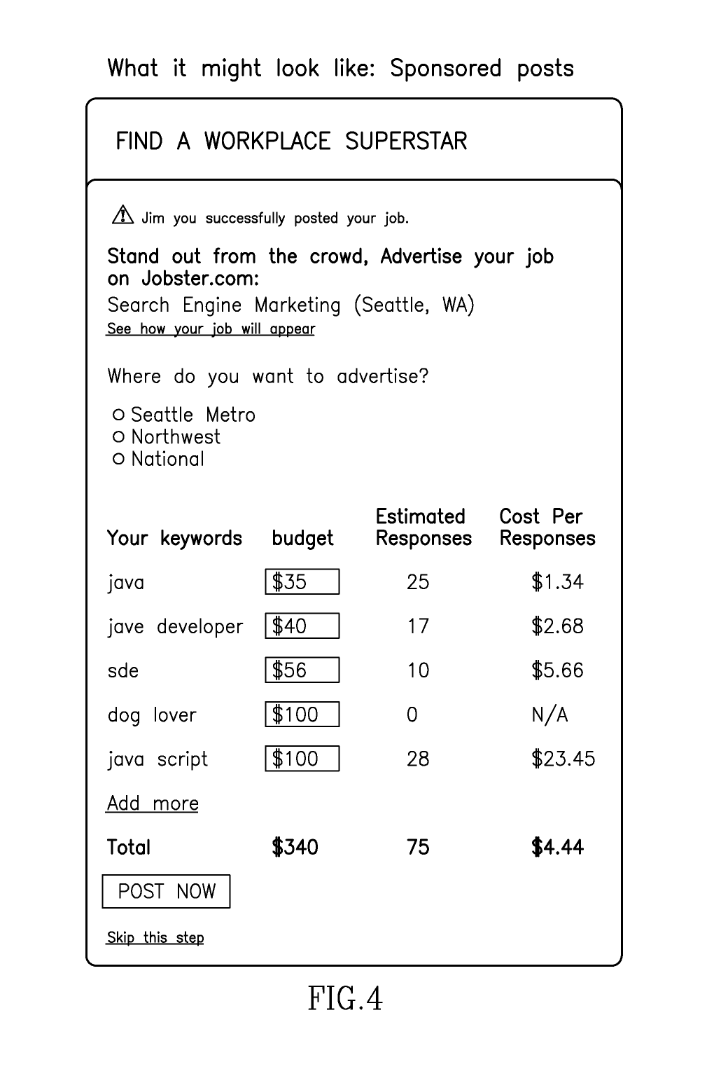

FIG. 4 is a mockup of what a control panel could look like that allows an advertiser to buy keywords and locations for a given job ad. An embodiment is applied specifically to job advertising.

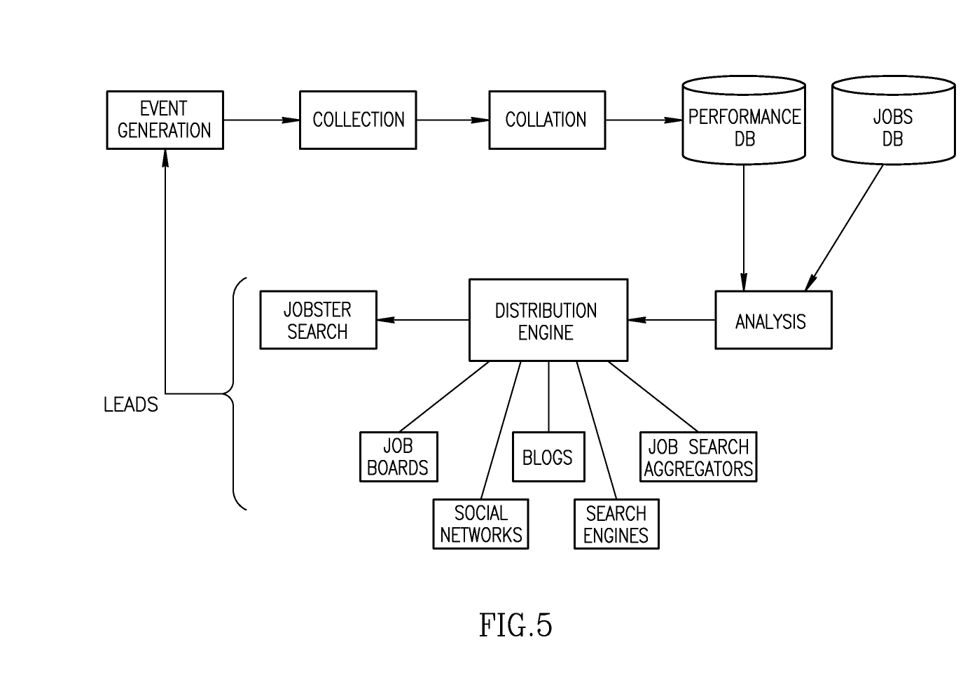

FIG. 5 is a schematic of a feedback loop for performance-based advertising.

In an embodiment, the Metrics project is about instrumenting our job search and jobster.com pages, as well as other advertising venues, to collect and collate data on job ad performance and user behavior. Having this data in usable, queryable form is optionally advantageous in order to make intelligent decisions about how to most effectively advertise jobs at the lowest cost. In an embodiment, this data is not necessarily collected (e.g. impression tracking), and if it is collected it may be in forms that are hard to query (multiple databases, in logs, in hitbox, not easily correlated).

This Metrics repository can become the source of not only ad-hoc analysis but also automated analysis jobs that can feed conclusions back into the job advertising engine on what jobs perform and how they should be served.

Feature List

An embodiment is about instrumentation, collection, and some collation. Embodiments of the invention include making the metrics available for ad-hoc querying and queuing us up to automate queries.

There may be three parts to an embodiment: event generation with defined sets of data, collection of this data, and collation.

Event Generation

The strategy for recording events can be to use syslog. The events themselves are generated from the coffeerobot pages. Events occur on
Impressions of jobs
Click-thru of jobs to landing pages
Inquiry

The data collected for these events includes:
Referrer/source (e.g. Facebook). This may be hierarchical to indicate source, campaign, inventory slot. For some pages this can be passed into Coffeerobot as a URL parameter e.g. the job landing page, in other cases it can be inferred e.g. referrer tag.
Tracking search terms for job or referring search engine page
Jobster user id, and/or saved search history cookie id
job alerts are a client of the query string convention
time to click through
# of search results, position and page number

The data schema particularly the referrer source tracking is designed to be extensible.

External keys for identifying jobs and events are described here:

1) Hitbox is already being used to track a good amount of categorized clickthrough data, and many links are already instrumented with hitbox query string parameters to identify the source context of the link.

2) To avoid duplication of effort and reinvention of terms, we'll borrow hitbox naming conventions where possible.

3) The logging function can take a hash of name-value pairs, including the following well-known names:
lid (location id)—a unique identifier for the page context where an impression or clickthrough occurs. For example, the hitbox lid for the job search results page is js_result.
lpos (link position)—a unique identifier for the page context where an impression or clickthrough occurs. For example, the hitbox lpos for the first job link in job search results is js_{—}01, and the lpos for the first featured job is tag_match_{—}01.
page—in a paged result set, the index of this page in that result set (e.g. 0 for the first page, 1 for the second page, etc.)
action—an identifier for the type of user interaction (e.g. impression, click, or inquiry)
referer—the URL of the referring page
*uuid—*unique user id
logged_in_user_id—jobster id of user, if logged in

The logging function writes the hash in a JSON format to a Syslog based lo

Collection

The second part is collecting the raw streams of data coming off each front end coffeerobot machine. Embodiments of the invention include using syslog dumping log strings into a “raw” database.

This can involve:
configuration of syslog
periodic vacuuming of syslog results
Consolidate with a simple log parser for the “raw” schema to dump into a db
Configuration of the “raw db.

Also we can put some energy into archiving deleted jobs in UJobs
UJobs deleted jobs archive bit
Periodic Cleanup task

Collation

The last step is normalization of the raw schema into a queryable schema, and any collation needed between event logfiles.
Define normalized schema
Convert raw schema into normalized schema

This schema is accessible to reports

Feature List
Choice of free or targeted (paid) in job post form

Free job post (FJP) is a good channel of leads to convert, maintains Jobster's free posting message
Pay-per-Inquiry model

Fixed pricing per inquiry for v1

Spending limit
Credit card payment with stored card profile

One card per user

Card info stored at payment vendor, not Jobster
Simple job list & management page

See all job posts

Upgrade job posts

Manage job posts that have expired or had problems
Email-based notifications of changes in job status

Upgrade FJP

FJP expiration

Spending limit reached

Credit card declined or expired
Feature jobs on Jobster.com search results

Unlimited inventory method
Track impressions, clicks, inquiries on a per-job basis
Time-based expiration of free job posts
Track out of band clicks on URLs and email addresses in job text
Scalable spam job screening administration

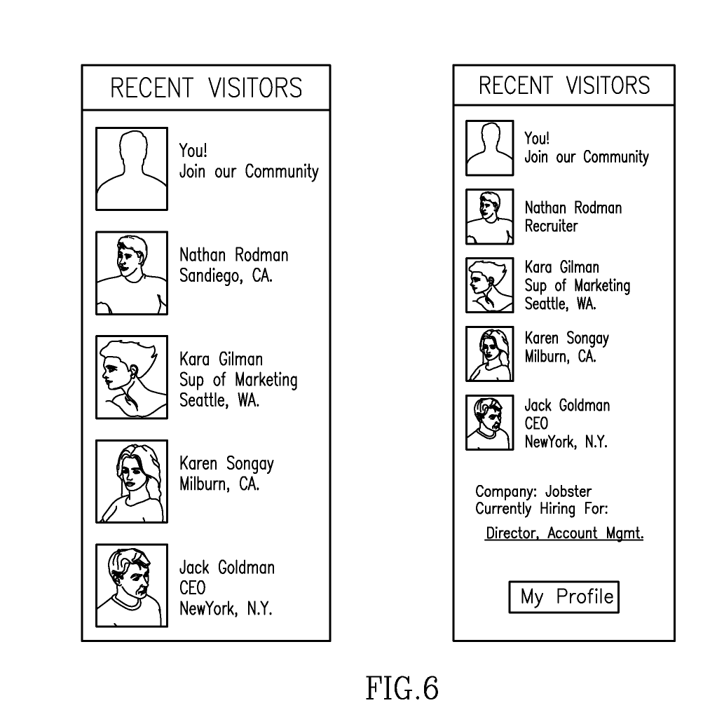

Referring to FIG. 6, the Jobster Blog Buddy is a blog widget that allows site owners to track participating visitors to their site and allow readers to register their presence on the site and advertise any jobs they have to offer. Distribution via the Blog Buddy is included in the value of a featured job post on Jobster.com. Site owners receive a share of the revenue received when a qualified applicant discovers a job via the Blog Buddy.

What is claimed is:

1. A method, comprising:
electronically posting an advertisement of a job opening with an employing entity;
receiving a notification that an applicant has applied to fill the advertised job opening; and
after receiving the notification, charging the employing entity a predetermined fee.
